(19) United States
(12) Patent Application Publication
(10) Pub. No.: US 2015/0120704 A1
(43) Pub. Date: Apr. 30, 2015

(54) System and Method for Suggesting the Viewing of Cultural Items Based on Social Tagging and Metadata Applications

(71) Applicants: DREXEL UNIVERSITY, Philadelphia, PA (US); KOREA ADVANCED INSTITUTE OF SCIENCE AND TECHNOLOGY, Daejon (KR)

(72) Inventors: S. Joon Park, Lebanon, NJ (US); Susan Wiedenbeck, Wynnewood, PA (US); Gunho Chae, Seoul (KR); Jungwha Kim, Daejon (KR)

(21) Appl. No.: 14/390,741

(22) PCT Filed: Apr. 5, 2013
(86) PCT No.: PCT/US2013/035366

§ 371 Date: Oct. 3, 2014

Related U.S. Application Data
(60) Provisional application No. 61/621,303, filed on Apr. 6, 2012.

(51) Int. Cl. G06F 17/30

(52) U.S. Cl. CPC G06F 17/30867
USPC 707/722

(57) ABSTRACT

A method of using social tagging to recommend cultural items includes the steps of providing an electronic database of cultural items, each of the cultural items having at least one descriptive keyword associated therewith; providing to a first user a first query with a first plurality of predetermined answers; associating each of the first plurality of predetermined answers with at least one of the descriptive keywords; receiving a selection input of one of the first plurality of predetermined answers from the first user; and displaying the cultural items associated with at least one of the descriptive keywords associated with the one of the first plurality of predetermined answers to the first user.

### CROSS-REFERENCE TO RELATED APPLICATION

This application claims priority from U.S. Provisional Patent Application Ser. No. 61/621,303, which was filed on Apr. 6, 2012, and which is incorporated herein by reference in its entirety.

### FIELD OF THE INVENTION

The present invention relates to a system and method that uses an art viewer's subjective input to recommend pieces of artwork that the viewer may desire to see.

### BACKGROUND OF THE INVENTION

In the recent past, museums have attempted to implement technology-mediated methods to increase the accessibility of online art collections and to improve the online and, ultimately, the actual, experience for visitors. Despite various attempts to improve this experience, the museums still lack an affective environment that can help untrained users to determine their interests in museum collections based on their affective states and preferences. Therefore, to properly support the needs of these users, it is necessary to develop novel approaches to enhance the museum experience.

### BRIEF SUMMARY OF THE INVENTION

Briefly, the present invention provides a method of using social tagging to recommend cultural items. The method includes the steps of providing an electronic database of cultural items, each of the cultural items having at least one descriptive keyword associated therewith; providing to a first user a first query with a first plurality of predetermined answers; associating each of the first plurality of predetermined answers with at least one of the descriptive keywords; receiving a selection input of one of the first plurality of predetermined answers from the first user; and displaying the cultural items associated with at least one of the descriptive keywords associated with the one of the first plurality of predetermined answers to the first user.

Additionally, the present invention provides a non-transitory machine-readable storage medium, having encoded thereon program code, wherein, when the program code is executed by a machine, the machine implements the method described above.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is an exemplary graphical user interface (GUI) showing an exemplary screen display of the present invention;

FIG. 2 is a flowchart illustrating the flow of information in the present invention;

FIG. 3 is a flowchart illustrating an exemplary question-and-answer process according to the present invention;

FIG. 4 is an exemplary GUI showing a first screen display of the present invention;

FIG. 5 is an exemplary GUI showing a second screen display of the present invention;

FIG. 6 is an exemplary GUI showing a third screen display of the present invention;

FIG. 7 is an exemplary GUI showing a fourth screen display of the present invention;

FIG. 8 is an exemplary GUI showing a fifth screen display of the present invention;

FIG. 9 is an exemplary GUI showing a sixth screen display of the present invention;

FIG. 10 is an exemplary GUI showing a seventh screen display of the present invention;

FIG. 11 is an exemplary GUI showing an eighth screen display of the present invention; and

FIG. 12 is exemplary GUI showing a ninth screen display of the present invention.

### DETAILED DESCRIPTION OF THE INVENTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

The present invention is a system and method for enhancing a cultural experience of a user of the system through user responses to questions generated by the system. Based on the user responses, the system provides recommendations to the user to view or experience a subset of specific items. Images of the items are provided on an electronic display to provide a representation to the user of the specific items.

The inventive system uses a social tagging system as an image retrieval technique. Such a technique is able to provide a consensus around the contents to be used in a search of a collection, such as an art collection, a music collection, or a motion picture collection (i.e., Netflix, On Demand, video streaming, electronic programming guide, etc.), to satisfy users who are not experts in a particular field. The social tags may include user-applied keyword metadata due to the fact that a rough consensus on the description and/or the subject of the artworks can be expected through such tags. Such an approach helps untrained users to easily refine their interests about the subject collections and to map those interests to terminology and metadata tags maintained by the host, such as, for example a museum. As a result, when using the inventive system, a user does not necessarily need to know what he/she is looking for. He/she does not have to be a subject matter expert with knowledge in a particular field or terminology in order to navigate by collections.

Further, when searching through collections, such as, for example, a music collection or a motion picture collection, other keyword metadata, including, but not limited to the artist/actor name, genre, age range of artist/actor, number of stars awarded by a critic, keywords (words and/or phrases) in reviews can also be used to navigate such collections.

By way of example, the inventive system can generate a series of questions for a user to answer. The answers to the questions can generate social tags that help the inventive system generate a recommended list of representations for the user to view. The questions may be formed to represent the six facets of museum tags: background, identification, theme, association, emotion, and figure.

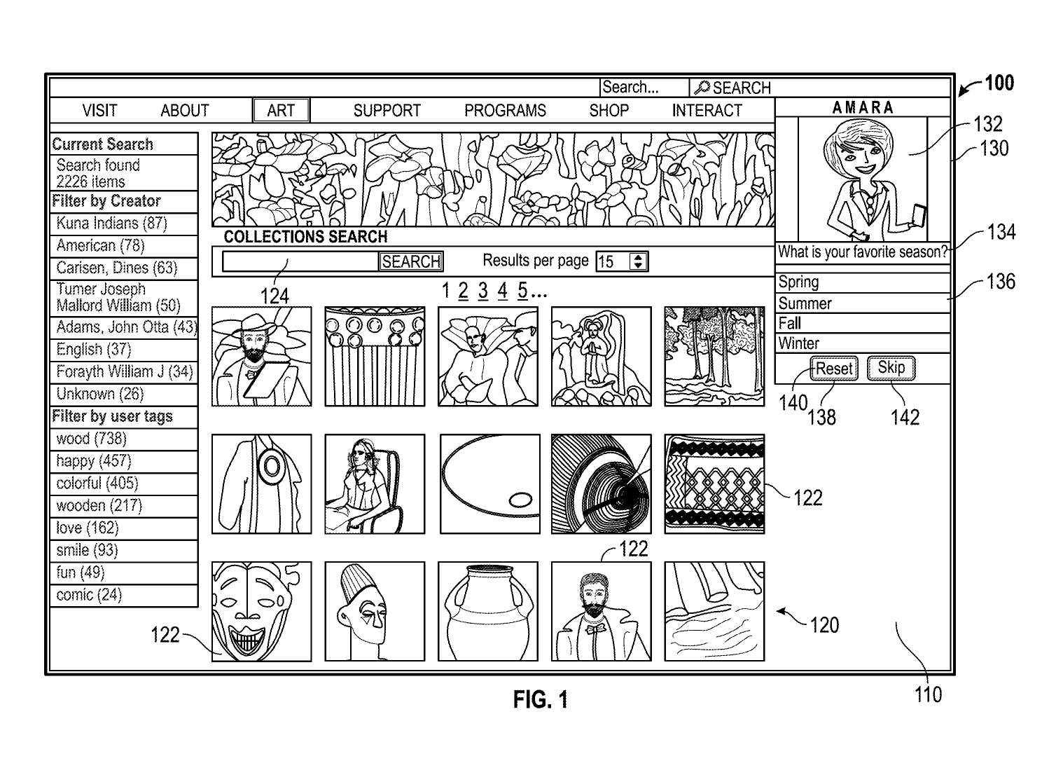

Referring to FIG. 1, an exemplary embodiment of the inventive system 100 being used to view art includes a GUI 110 with which a user interacts to operate system 100. GUI 110 includes a webpage 120 that displays a plurality of representations 122 of options available for viewing. As shown FIG. 1, representations 122 may be photographs of artwork.

While an exemplary embodiment of the present invention may be used in a museum, those skilled in the art will recognize that the inventive system and method can be used in other locations, such as for example, geographic or historical locations in a city, a store (i.e., a clothing store or a supermarket), or any place where user may want to go and make decisions based on emotions. Alternatively, another exemplary embodiment of the present invention may be used to help the user prepare a meal based on the user's present emotions and hunger desires. For ease of description of the invention, however, the exemplary embodiment of cultural items, such as artwork in a museum, is used, with representations 122 being pictures of artwork on display in an exemplary museum.

In an exemplary embodiment, the inventive system can be accessed via a generally stationary home computer, a mobile device, such as, for example a cell phone, or other such electronic device that has a display and input capabilities. Additionally, the inventive system can be accessed via a kiosk located within or proximate to the location that the user intends to visit. System 100 can also be used prior to a user visiting the museum so that the user can determine what artwork he/she may desire to view while visiting the museum.

Museums have spent a tremendous amount of time and resources digitizing their art collections with the intention of providing an online alternative for art enthusiasts who wish to browse or search for artworks, without, prior to, or after visiting the actual museum itself. System 100 takes advantage of this digitization to enhance the museum experience.

In exemplary embodiment, the backend functionality of system 100 can be built using known and commonly used scripting languages, such as, for example PHP Hypertext Preprocessor, MySQL, and Apache Web server. The front end interface of system 100 may be created using Adobe Flash for the animated graphical agent and HTML, CSS and JavaScript for the question-based search interaction. System 100 may be operated through web browsers, such as, for example, Chrome and Safari.

GUI 110 includes a search text box 124 that receives input from the user, such as, for example, social tags, that can be used to generate suggested representations 122 of artwork that the user might desire to view based on the input.

GUI 110 also includes a search agent 130 that receives input from the user to generate recommended representations 122 for the user to view. Search agent 130 includes three basic parts: a graphical embedded agent 132, a text-based interaction window 134 with answer boxes 136, and navigation buttons 138. As shown FIG. 1, navigation buttons 138 include a “Reset” button 140 and a “Skip” button 142. Those skilled in the art, however, will recognize that navigation buttons 138 can provide other options as well.

Search agent 130 uses a graphically-embedded agent-based approach in order to make the user's search experience more affective and enjoyable. In an exemplary embodiment, embedded agent 132 is a female docent with animation effects. It is believed by the inventors that a female docent appears more empathetic, interesting, and enjoyable and can better elicit the user's emotions and preferences during the inventive search process.

Search agent 130 uses interactive techniques to incorporate a user's emotions and preferences during its search process. Search agent 130 interacts with the user in text form and allows the user to use various inputs such as a mouse and keyboard or a touchscreen to answer various types of multiple-choice and open-ended questions provided by search agent 132 the user in order to determine the user's interest in a particular field such as, for example, art.

In an exemplary embodiment, 190 questions have been developed for search agent 130 to ask the user so that the user will not get the same questions when he/she repeats the search process. The questions are developed so that the answers can be mapped with popular social tags, which are in turn linked to related artworks. By way of example, in developing an exemplary search agent 130, 318,810 social tags were analyzed, with 5,160 recurring social tags used on an exemplary museum website. Questions and potential answers were developed based on six dimensions of classifications of tags, which include: background, identification, theme, association, emotion, and figure. When using system 100, users do not need to know what they're looking for. System 100 can be used by those who are not subject matter experts with knowledge in art historical technology to navigate art collections.

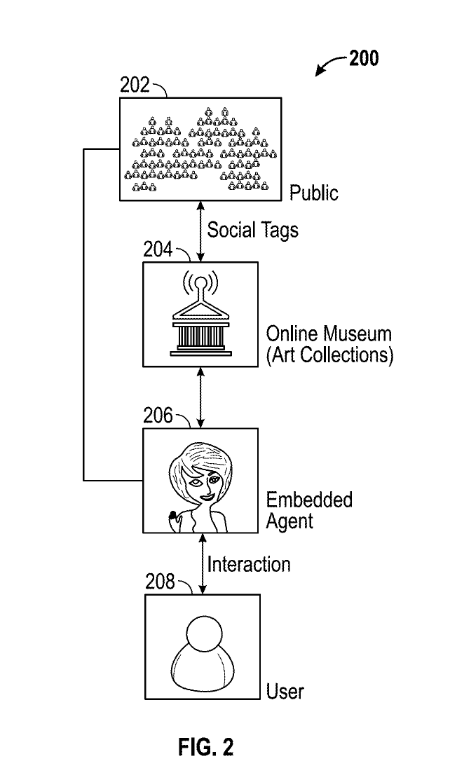

FIG. 2 displays an exemplary flowchart 200 that provides an exemplary method of using system 100 based on social tags. In block 202, a number of members of the public can view different pieces of artwork in block 204 and generate social tags to associate with each piece of artwork in a museum based on what they see in the piece or how the piece makes them feel. For example, a picture of a piece of artwork that includes a pigeon may generate tags such as, for example, “pigeon”, “bird”, “dove”, and “fly”. Each piece of artwork may generate more than one different tag. For example, in addition to the tag “pigeon”, the same piece of artwork may also be tagged with the word “sky” if the pigeon is seen to be flying, and/or the word “gray” if the background of the artwork shows a gray sky. After all of the available artwork has been tagged, a word frequency analysis can be performed, with tags that are used only one or two times being omitted. By omitting tags that are used only one or two times, a significant consensus is formed.

A plurality of social tags is associated with each representation 122 in a database in system 100. The social tags are used to filter representations 122 down to a relatively small number for a user to view through system 100 and subsequently, at the museum itself.

In block 206, search agent 130 asks randomly selected questions from a list of predefined questions that are described in more detail below. Based on the answers that are provided by the user in block 208, system 100 uses the tags associated with answers to the questions in order to select representations 122 to display on webpage 120.

In an exemplary embodiment, system 100 may ask three multiple-choice questions and one open-ended question after the three multiple-choice questions. Those skilled in the art, however, will recognize that different numbers and different types of questions may be used and the order of the types of questions may be rearranged. The questions generally pertain to the user's preferences and interests in artwork. After each question is answered, system 100 displays relevant representations 122 so that the user can understand how his/her answers are reflected in the search results. At various points during the questioning process, the user can skip a question or reset the process from the beginning by clicking on button 142 on GUI 110.

During the search process, representations 122 with frequently occurring tags are displayed first to increase the relevance of the results. For the open-ended question, if the answer is the exact term that matches with any of the existing tags, representations 122 under that particular term will be retrieved to display as results. In the event that the exact term inputted by the user does not match any existing tags, no updates will display in the results.

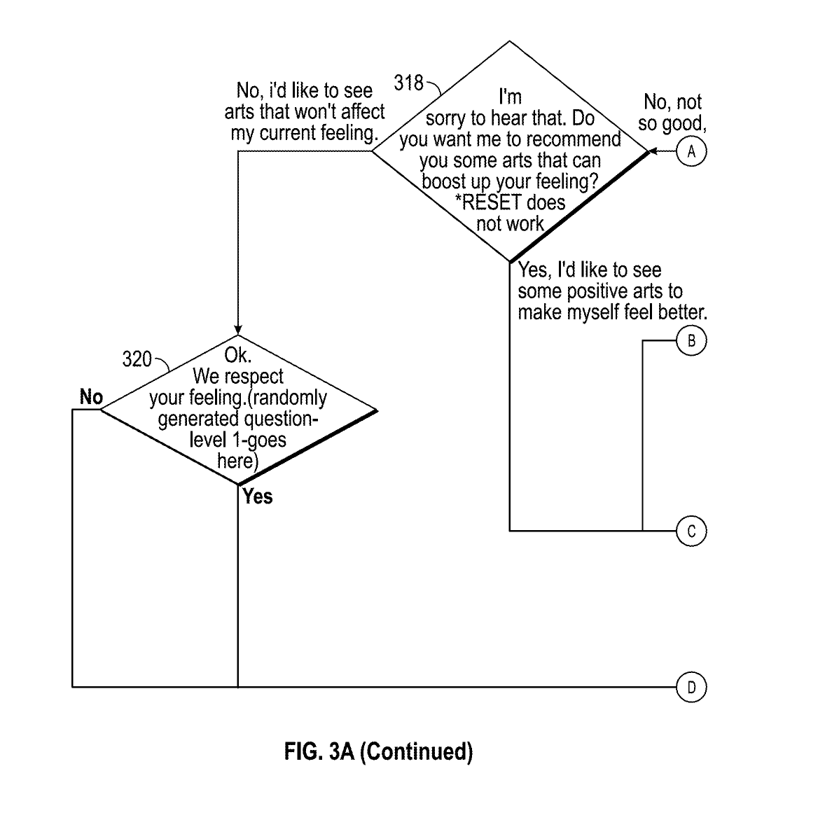

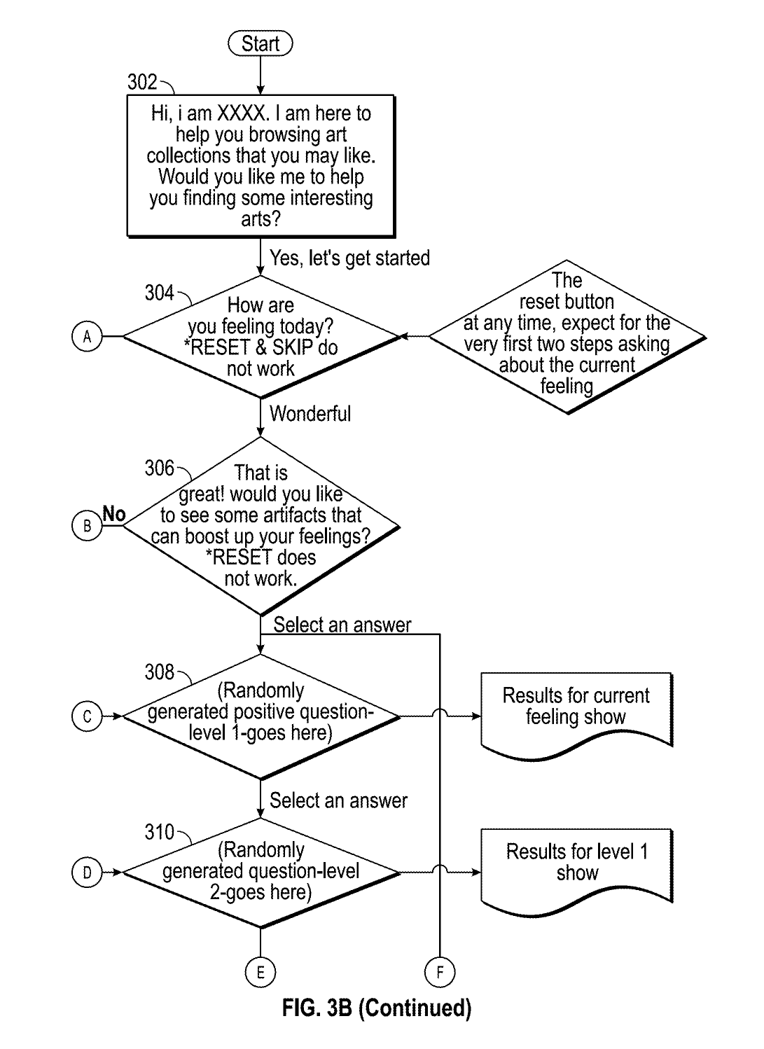

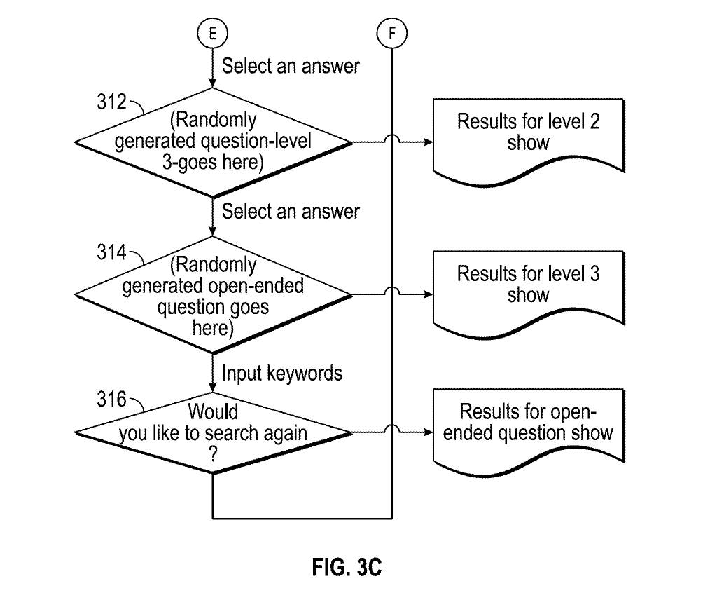

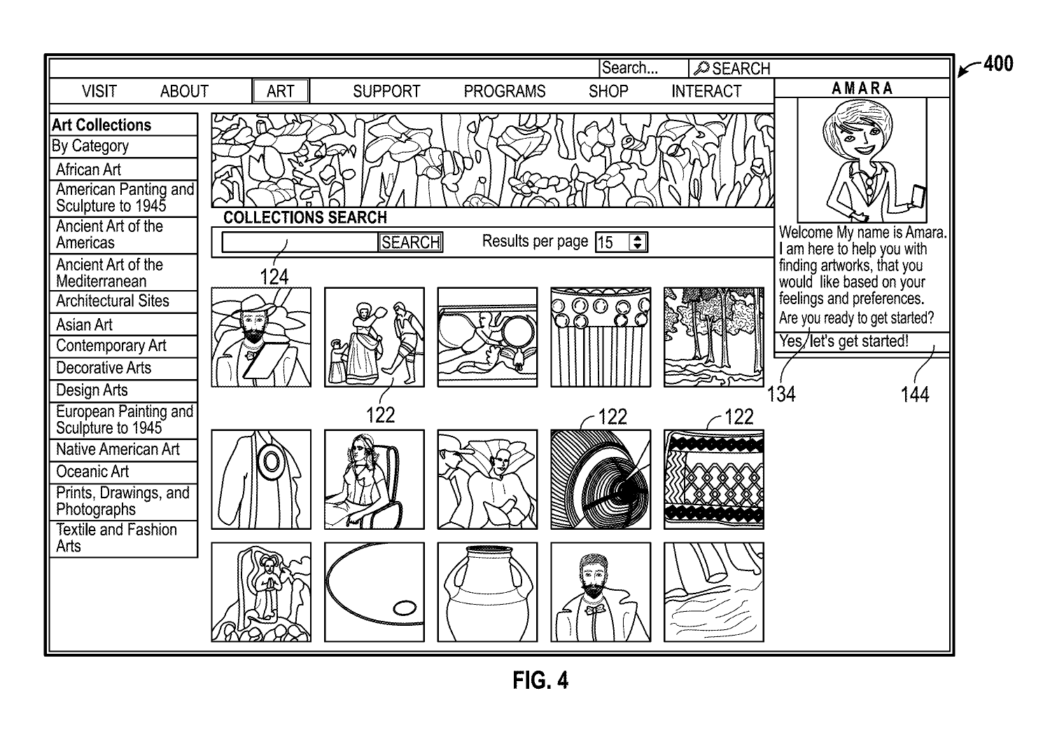

Referring to the flowchart 300 of FIG. 3, when a user first operates system 100, in an exemplary embodiment, in step 302, embedded agent 132 introduces herself in natural language in box 134, shown in GUI 400 of FIG. 4. System 100 uses simple and affective language so that users with various educational backgrounds can easily read the questions and the answer choices provided. A “Yes, let's get started!” box 144 is provided for the user to click on in order to start the process of selecting representations 122 for the user to view.

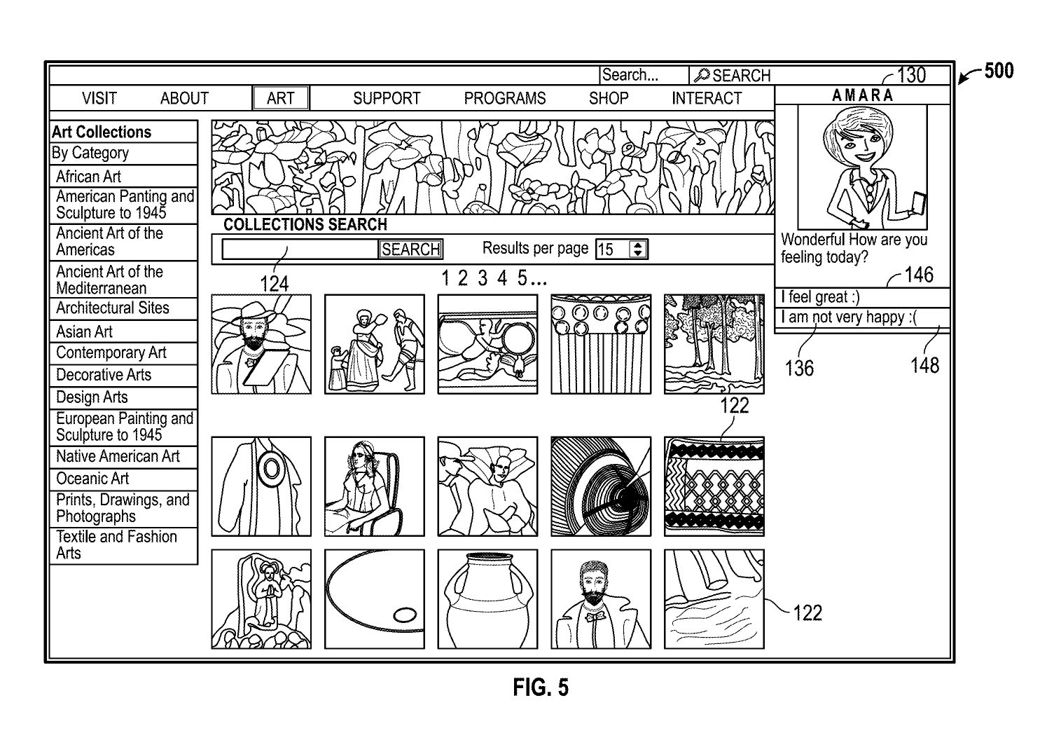

In step 304, system 100 first asks about the user's current affective state, shown in GUI 500 of the FIG. 5. The user has the option of clicking on box 146 which the user states that he/she feels great or box 148, in which the user states that he/she is not very happy. Note that, in step 304, “Reset” button 140 and “Skip” button 142 are not available.

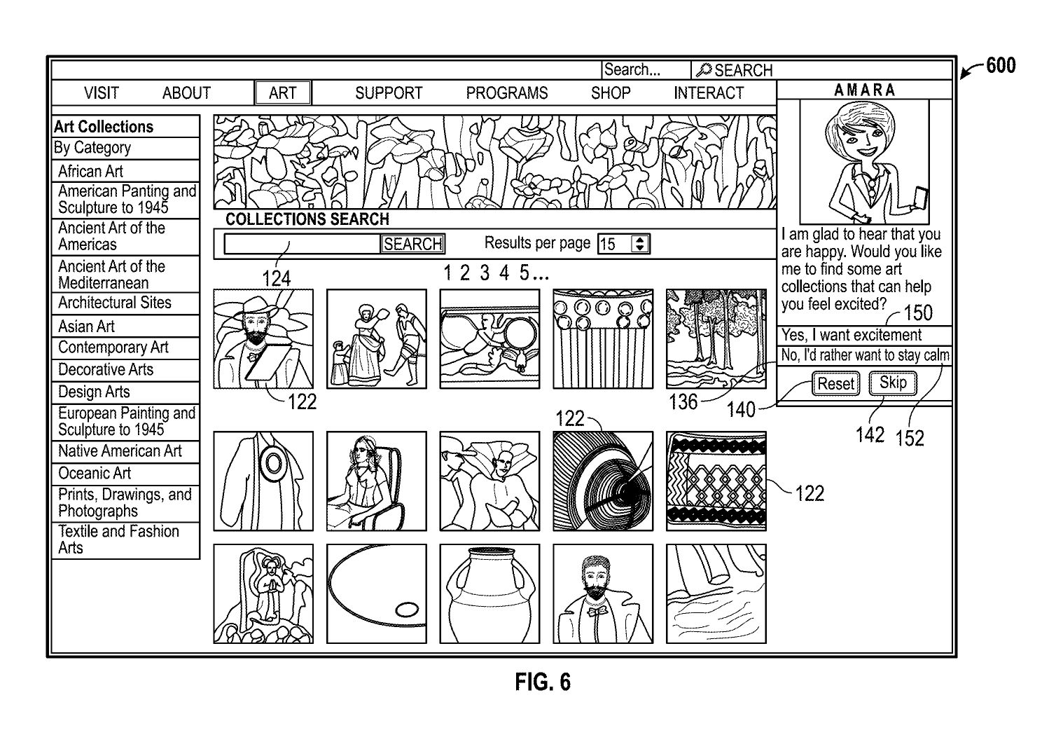

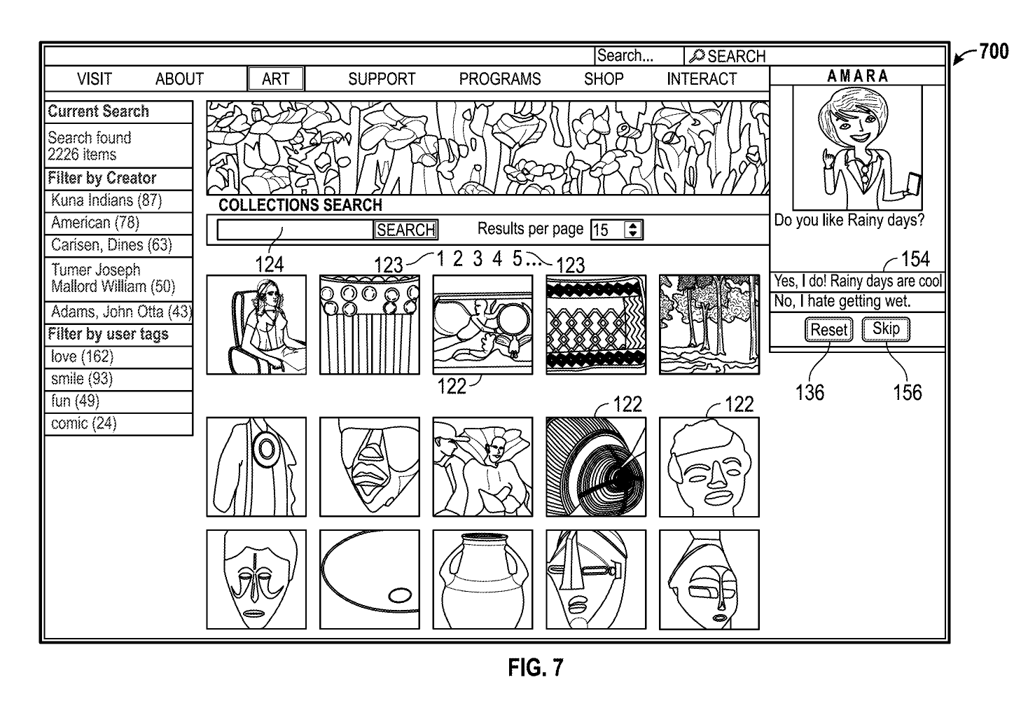

If, in response to the question in step 304, the user feels great, system 100 moves to step 306 shown in GUI 600 of FIG. 6. In step 306, system 100 asks the user if the user would like to boost up his/her feelings. The user has the option of clicking on box 150 if the user wants excitement or on box 152 if the user wants to stay calm. Note that, in step 306, the “Reset” button 140 is disabled. Regardless of whether the user would like to boost up his/her feelings or not, system 100 moves to step 308, shown in GUI 700 of FIG. 7, in which a randomly generated positive question, selected from the first column of TABLE I below, is presented in box 134. Potential answers to the question, selected from the second and third columns of TABLE I, are presented in box 136.

TABLE I
Questions

| | | |
|---|---|---|
| Do you like nature? | Yes, I love it! | No, I am a city person. |
| | sky, tree, mountain, river, | city, building, factory |
| | sea, nature | |
| Do you like landscapes? | Yes, I love it! | No, I am a city person. |
| | sky, forest, mountain, | city, building, factory |
| | landscape, river, sea | |
| Do you like dark colors? | Yes, I like dark colors. | No, I like bright colors. |
| | darkblue, darkgray, | lightblue, red, orange, |
| | darkgreen, darkslategray, | colorful, orangered, yellow |
| | tan | |
| Do you like bright colors? | Yes, I like bright colors. | No, bright colors are |
| | | annoying. |
| | lightblue, pink, lightpink, | dark, darkblue, darkgray, |
| | orange, colorful | darkgreen, darkorange, |
| | | darkred, darkslategray, |
| | | tan, shadow |
| Do you like colorful | Yes, I love it! | No, it would drive me |
| artwork? | | nuts. |
| | colorful, red, orange, | beige, brown, tan, shadow |
| | blue, yellow, pink | |
| Do you like rainy days? | Yes, I do! Rainy days are | No, I hate getting wet. |
| | cool. | |
| | cloudy, rain, gloomy, | sunny, sunshine, sunlight |
| | clouds, cloudysky | |
| Which theme do you | Nature | Urban landscapes |
| prefer in art collections? | | |
| | sky, water, tree, | city, building, factory, |
| | mountain, hill, landscape, | industry, village, |
| | river, sea, nature, rocks | development |
| Do you like Asian prints? | Yes, they are fascinating! | No, I'm not interested in |
| | | Asian art. |
| | china, chinese, japan, | european, american, |
| | japanese, asian, kimono, | africa, african, |
| | oriental | impressionism |
| Do you like floral prints? | Yes, I love them! | I'm allergic to flowers. I |
| | | prefer animals. |
| | floral, flower, vase | dog, rabbit, cat, puppy |
| Do you like animals? | Yes, I love animals! | No, they smell funny. I |
| | | prefer flowers. |
| | bird, animals, dog, rabbit, | floral, flower, vase |
| | cat, horse, tiger | |
| Do you like the ocean or | Ocean | Mountains |
| mountain? | | |
| | ocean, sea, seascape, | mountain, hill, hillside |
| | seaside | |
| Do you like babies? | Yes, I love babies. | No, babies have stinky |
| | | diapers. Grown ups |
| | | please! |
| | baby, babyangels, child, | man, lady, gentleman, |
| | children | woman |
| What do you look for in | Bright colors | Dark colors |
| artwork? | | |
| | red, orange, colorful, | darkblue, darkgray, |
| | orangered, yellow | darkgreen, darkorange, |
| | | darkred, tan, shadow |
| Do you like traditional | Yes, I love it. | No, it is boring. I prefer |
| art? | | modern art. |
| | traditional, landscape, | modern, cubism, |
| | portrait, antique | contemporary, abstract, |
| | | minimal, |
| | | nonrepresentational |
| Would you like to see | Yes, that'd be interesting. | The worlds is serious |
| some serious artworks? | | enough. Show me |
| | | something funny. |
| | serious, seriousface, | fun, funny, happy |
| | seriousemotion, horror, | |
| | dead, death | |
| Do you like to keep your | Yes, I like it pitch black! | No, I get depressed |
| place dark? | | without light. |
| | darkblue, darkgray, | lightblue, lightblue, |
| | darkgreen, darkslategray, | lightpink, sun, sunshine |
| Do you prefer | I love impressionism. | No, show me something |
| impressionism over | | modern. |
| modern art? | | |
| | impressionism, | modern, contemporary, |
| | impressionist, | minimal, abstract |
| | impressionistic | |
| Do you like artworks that | Yes, put me in a good | No, I don't feel like |
| make you laugh? | mood! | laughing. A little more |
| | | serious please! |
| | fun, comedy, comic, | serious, seriousface, |
| | funny | seriousemotion |
| Are you interested in | Definitely! I love luxury! | Not really. I want to see |
| seeing how artists | | something more simple. |
| describe a luxurious | | |
| lifestyle? | | |
| | luxury, luxurious, rich, | village, folk, tradition |
| | gold, diamond, golden | |
| Do you like nude artwork? | Of course, I do! Yay! | No! That's nasty! Clothes |
| | | on only! |
| | nude, erotic, naked, | portrait |
| | shirtless, sensual, lust | |
| Do you like realistic art? | Yes, I do. | No, I want to see |
| | | something realistic. |
| | real, realistic, portrait, | abstract, abstractshape |
| | photo, photograph | |
| Do you like abstract art? | Yeah, it is fascinating. | [symbol] realistic [symbol] |
| | abstract, abstracted | real, realistic, portrait, |
| | | photo, photograph |
| Do you think kittens are | Yes, they are precious! | No, they shed |
| adorable? | | everywhere! I prefer dogs. |
| | kitten, kitty, cat, cats | dog, puppy |
| Do you think puppies are | Oh my god, yes! I love | No, they poop |
| cute? | them. | everywhere. I prefer cats. |
| | puppy, dog | kitten, kitty, cat, cats |
| Do you like the sound of | Yes, it is very good. | No, I'd rather listen to the |
| waves crashing? | | sounds of the forest. |
| | sea, ocean, seaside, | forest, mountain |
| | wave, wavecrash | |
| Are you interested in | Yes, I love photographic | No, I don't like them. |
| seeing artworks in | arts. | |
| photography? | | |
| | photography, photo, | painting, paint, painted, |
| | realism | drawing, ceramic, carved |

While the question and potential answers are presented in search agent 130, representations 122 that are based on the answer provided in step 306 are provided in GUI 700. Pre-assigned tags are mapped to selected representations 122 for the question. In an exemplary embodiment, assigned tags that are linked with “Yes, I want some excitement” are “happy”, “fun”, “smile”, and “comic”, while tags that are linked with “No, I'd rather stay calm” are “calm”, “relax”, “peace”, and “relaxing”. The tags linked to these answers are very general because this is the first question asked by system 100. Typically about 15 representations 122 are displayed. Additional results can be viewed by clicking on one of the numbers in the that are displayed above the top row of representations 122.

In each of the second and third columns of TABLE I, below each answer, is a series of words that are separated by commas. These words are the social tags associated with the response immediately above the words. System 100 generates representations 122 that have been associated with these social tags database and displays the representations 122 in GUI 700.

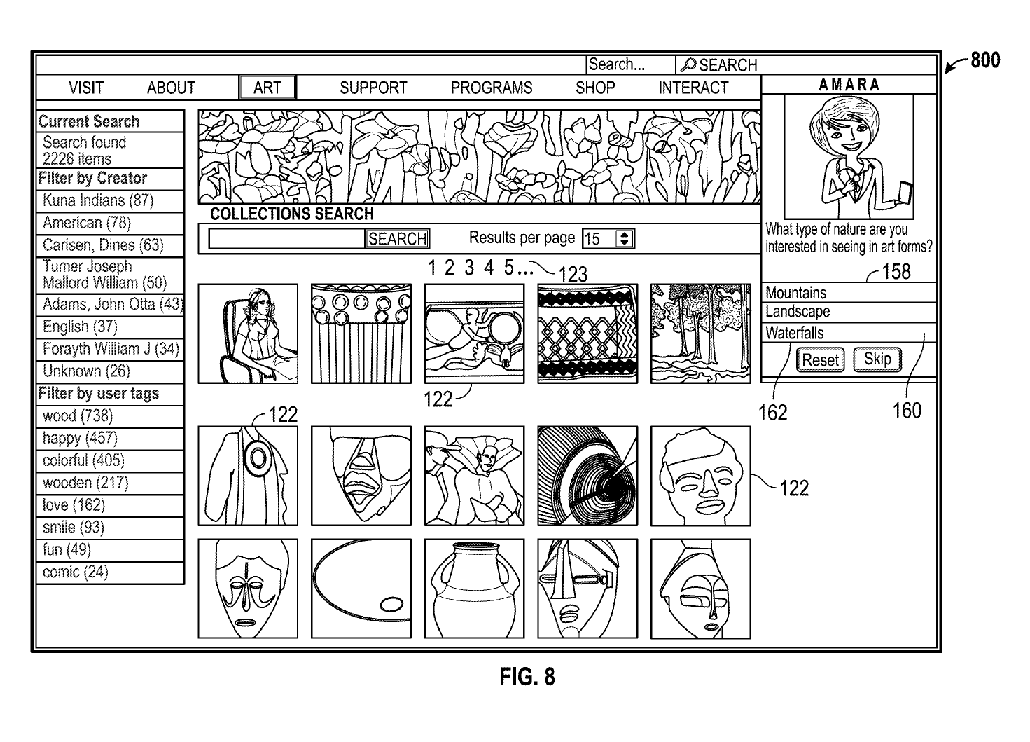

When the user clicks on either box 154 or 156, system 100 associates the answer with the social tags located directly below the answer in TABLE I and generates GUI 800, shown FIG. 8, with representations 122 being selected based on the representations 122 associated with those particular social tags.

In order to further narrow down the number of representations 122 that are displayed in GUI 800, system 100 moves to step 310 and generates a new question, selected from the first column of TABLE II below, in block 134. Note that, while GUI 700 has two blocks 154, 156 for answers, GUI 800 has three blocks 158, 160, 162 for answers. Similarly, TABLE II has three columns (columns 2, 3, and 4) for responses. Similar to TABLE I, TABLE II has social tags associated with each response listed immediately below the respective response.

TABLE II
Questions

| | | | |
|---|---|---|---|
| Where would you | Mountains | Beach or Ocean | I'd just stay at |
| like to go for your | | | home |
| vacation? | | | |
| | mountain, hill, | beach, sea, ocean, | room, indoor, |
| | hillside | seascape | home, house |
| What kind of | Human | Animal | Nature |
| subject do you | | | |
| prefer when you | | | |
| see artworks? | | | |
| | portrait, man, lady, | bird, animals, dog, | sky, tree, |
| | gentleman, woman | rabbit, cat, horse, | mountain, hill, |
| | | tiger | landscape, river, |
| | | | sea |
| What is your | Christmas | Thanksgiving day | Valentine day |
| favorite holiday? | | | |
| | snow, christmas, | fall, autumn, | love, romantic, |
| | angel, winter | turkey, harvest, | romance, |
| | | hay | chocolate |
| When you watch | Romantic Movie | Comic Movie | Horror movie |
| movie, which | | | |
| genre do you | | | |
| prefer? | | | |
| | love, lovely, | fun, comedy, | horror, scary, |
| | romantic, romance, | comic, funny | anger, fear |
| | affection | | |
| What kind of color | Vivid and colorful | Dark and gloomy | Achromatic colors |
| do you like? | | | |
| | red, lightpink, | dark, tan, shadow | black, gray, white, |
| | orange, colorful, | | lightgray |
| | yellow | | |
| Which topic are | Love | Death | Birth |
| you interested to | | | |
| see in art? | | | |
| | love, romantic, | death, dead, die, | birth, baby, |
| | romance, affection | dying | birthday, cake |
| What material do | Marble | Wood | Bronze |
| you prefer the | | | |
| most in art forms? | | | |
| | marble, marbled | wood, wooden, | bronze |
| | | woods | |
| Which shape are | Rectangle | Circle | Parallelogram |
| you interested in | | | |
| seeing in | | | |
| artworks? | | | |
| | rectangular, | circle, round | parallelogram, |
| | rectangles | | parallellines |
| Would you like to | Standing | Sitting | Laying down |
| see a model | | | |
| standing up or | | | |
| sitting in | | | |
| artworks? | | | |
| | standing, stand | chair, sofa, sit, | bed, sleep, |
| | | sitting | sleeping, |
| Which facial | Smiling | Crying | Surprised |
| expression do you | | | |
| prefer? | | | |
| | smiling, smile, fun | cry, crying, sad, | surprise, shock, |
| | | sadness, tear | surprised |
| Which era are you | Middle ages | Modern ages | Current |
| interested in | | | |
| seeing in | | | |
| artworks? | | | |
| | medieval, gothic, | modern, minimal, | contemporary |
| | tapestry, antique | cubism, abstract | |
| Do you prefer | I want to see | I'd like to see | I love them all! |
| children or babies? | children in | babies in artworks. | |
| | artworks. | | |
| | boy, girl, children | baby, babyangels | boy, girl, children, |
| | | | baby, babyangels |
| What makes you | A picnic in green | Playing with | Kissing |
| feel joyful? | pastures | children | |
| | picnic, forest, tree, | kid, boy, girl, child, | kiss, kissing |
| | park | children, | |
| | | playground | |
| Who is your | Andy Warhol | Picasso | Van Gogh |
| favorite artist? | | | |
| | andywarhol, warhol | picasso, | vangogh, |
| | | picassoesque, | vangoghish |
| | | picassolike | |
| What type of art | Textile | Pottery | Painting |
| form are you | | | |
| interested in? | | | |
| | textile, texture, | ceramic, pottery, | paint, painting, |
| | textured, | pot | dwawing |
| | embroidered, | | |
| | embroidery, | | |
| | tapestry | | |
| Do you prefer | Yes, I love | No, I like | I like both. |
| paintings over | paintings. | sculptures better. | |
| sculptures? | | | |
| | painting, painted, | sculpture, carved, | sculpture, carved, |
| | drawing | carving | carving, painting, |
| | | | painted, drawing |
| Which animal do | Pigs | Pigeons | Ponies |
| you like to see in | | | |
| art collections? | | | |
| | pig | pigeon, pigeons, | pony, horse |
| | | bird | |
| Who is your | Rembrandt | Picasso | Van Gogh |
| favorite artist? | | | |
| | rembrandt, | picasso, | vangogh, |
| | rembrant | picassoesque, | vangoghish |
| | | picassolike | |
| Which fashion | How artists express | How artists | How artists |
| feature in portraits | coats in paintings | express dresses in | expressed jewelry |
| are you interested | | paintings | in different art |
| in seeing? | | | forms |
| | coat, jacket | dress, gown | jewelry, ring, |
| | | | necklace, jewel, |
| | | | diamond, earring, |
| What type of | Mountains | Landscape | Water falls |
| nature are you | | | |
| interested in | | | |
| seeing in art | | | |
| forms? | | | |
| | mountain, hill, | landscape, | waterfall |
| | hillside | scenery, trees, | |
| | | outdoors, clouds, | |
| | | sky, wind | |
| What kind of art | Nude | Landscape | Portrait |
| collections are you | | | |
| interested in | | | |
| finding? | | | |
| | nude, erotic, naked, | landscape, | portrait, man, |
| | shirtless, sensual, | scenery, trees, | gentleman, woman |
| | lust | outdoors, clouds | |
| Do you like | Yes, I love flowers! | No, they make me | No, but I love |
| flowers? | | sneeze. Animals | animals. |
| | | please! | |
| | floral, flower, | | |
| | flowers, vase, grass | | |
| Are you interested | Yes, that'd be | No, I'd like to see | No, I'd like to see |
| in seeing religious | interesting. | everyday people. | some nature. |
| artworks? | | | |
| | religious, christ, | village, folk, | landscape, nature, |
| | christian, church, | tradition | mountain, river |
| | praying, buddha | | |
| Are you interested | Yes, that'd be | No, who cares | No, who cares |
| in seeing how | interesting! | about furniture! I | about furniture! I |
| artists describe | | want to see some | am fine with |
| furniture in | | people in art. | seeing different |
| artworks? | | | landscapes in art. |
| | furniture, chair, | portrait, man, | landscape, sea, |
| | sofa, closet, couch, | woman, kid | forest, lake |
| | table | | |
| Would you like to | Yes, I like portraits. | Nah, show me | Nah, I like |
| see some | | something lively. | landscapes and |
| portraits? | | | nature. |
| | portraits, person, | village, folk, | landscape, nature, |
| | girl, man, lady, | tradition | mountain, river |
| | gentleman, woman, | | |
| | child, children, face, | | |
| | portrait | | |
| Do you like | Yes, I love it. | Hmm. I like | You know what? I |
| modern art? | | traditional art. | like to see some |
| | | | Asian artworks! |
| | modern, cubism, | medieval, | china, asian, |
| | contemporary, | paingting, | japanense |
| | abstract, minimal, | expressionism | |
| | nonrepresentational | | |
| Do you like textile | Yes, it is | No, who cares | No, who cares |
| artwork? | fascinating. | about textiles! I | about textiles! I |
| | | love painting. | love sculpture and |
| | | | ceramic. |
| | textile, texture, | drawing, painting | ceramic, sculpture, |
| | textured, | | carved |
| | embroidered, | | |
| | embroidery, | | |
| | tapestry | | |

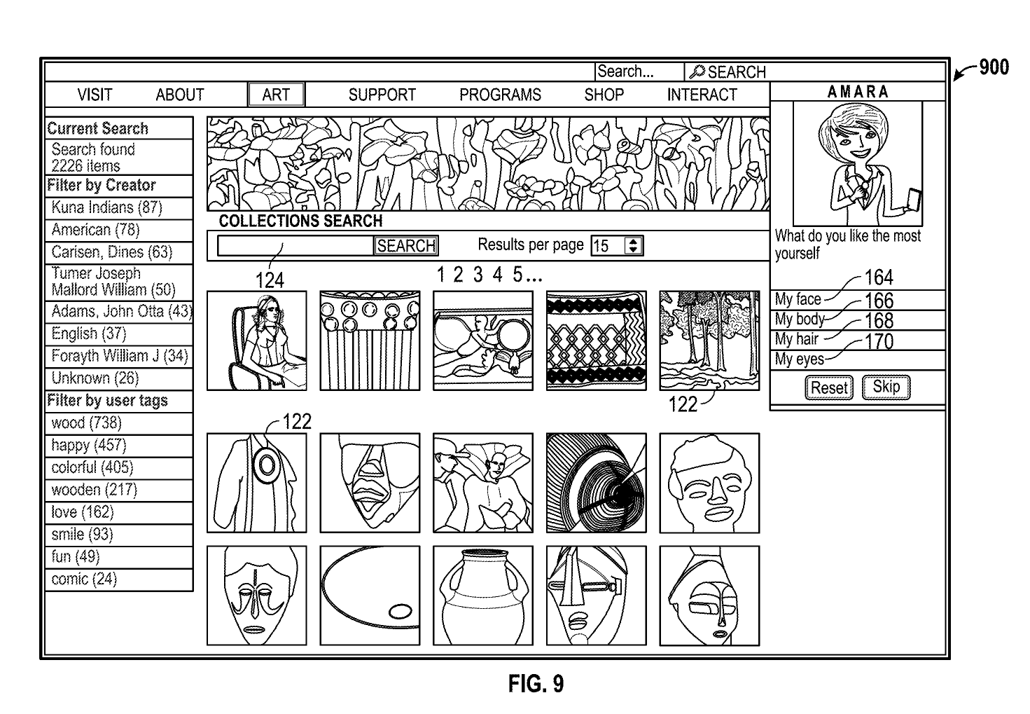

When the user clicks on one of the blocks 158, 160, 162, system 100 moves to step 312 and narrows down the results that were shown in GUI 800, which are shown in GUI 900 in FIG. 9.

When the user clicks on any of box 158, 160, 162, system 100 associates the answer with the social tags located directly below the answer in TABLE II and generates GUI 900, shown FIG. 9, with representations 122 being selected based on the representations 122 associated with those particular social tags.

In order to further narrow down the number of representations 122 that are displayed in GUI 900, system 100 moves to step 312 and generates a new question, selected from the first column of TABLE III below, in block 134. Note that, while GUI 800 has three blocks 158, 160, 162 for answers, GUI 900 has four blocks 164, 166, 168, 170 for answers. Similarly, TABLE III has four columns (second, third, fourth, and fifth column) for responses. Similar to TABLE II, TABLE III has social tags associated with each response listed immediately below the respective response.

TABLE III
Questions

| | | | | |
|---|---|---|---|---|
| What is your | Spring | Summer | Fall | Winter |
| favorite | | | | |
| season? | | | | |
| | spring, flower, | summer, sun, | fall, leaf, | winter, snow, |
| | green | sunlight, beach | leaves, | snowing, cold |
| | | | autumn | |
| Which animal | Birds | Dogs | Rabbits | Cats |
| do you like the | | | | |
| most? | | | | |
| | bird, birds | dog, dogs, | rabbit | cat, kitty |
| | | puppy | | |
| What do you | Vanity | Anger | Happiness | Indulgence |
| think is the | | | | |
| most | | | | |
| interesting | | | | |
| about human | | | | |
| nature? | | | | |
| | vanity, vain, | anger, angry, | happy | food, eat |
| | gold, luxury | furious, fear | | |
| What theme | Family- | Frienship- | Romantic | Loneliness |
| interests you | oriented | oriented | themes | themes |
| the most? | themes | themes | | |
| | family | friend, | love, lovely, | loneliness, |
| | | friendship | romantic | lonely, |
| | | | | lonelyman |
| What do you | Passion | Love | Horror | Curiosity |
| think is the | | | | |
| most | | | | |
| interesting | | | | |
| about human | | | | |
| nature? | | | | |
| | passion, | love, romance, | horror, fear | curiosity, |
| | passionate | affection | | curious, |
| What would | Calm skies | Water falls | Snow | Green pastures |
| make you feel | | | | |
| the best? | | | | |
| | calm sky, sky | waterfall | snow, snowing | tree, tress, |
| | | | | forest |
| What type of | Mountains | Water falls | Oceans | Fields |
| landscape do | | | | |
| you prefer the | | | | |
| most? | | | | |
| | mountain, hill, | waterfall | ocean, beach, | field, |
| | hillside | | sea, seaside | countryside, |
| | | | | farm |
| What do you | Eyes | Shoulders | Body | Legs |
| find sexy? | | | | |
| | Expressive | shoulder | body | leg, legs |
| | eyes, eye | | | |
| What do you | My face | My body | My hair | My eyes |
| like the most | | | | |
| about | | | | |
| yourself? | | | | |
| | face | body | hair | eye |
| What type of | Candy | Meat | Fish | Vegetables |
| food do you | | | | |
| like to pig out | | | | |
| on? | | | | |
| | candy | meat | fish | vegetable |
| Are you | Yes, I am | No, I'd rather | How about | I'd like to see |
| interested in | interested! | see some | both drawings | some porcelain |
| seeing some | | photography | and | figures. |
| drawings? | | artworks. | photography | |
| | | | artworks? | |
| | painting, | photo, | drawing, | ceramic, |
| | paint, painted, | photograph, | photograph, | carved, |
| | drawing | tapestry, | photo | |

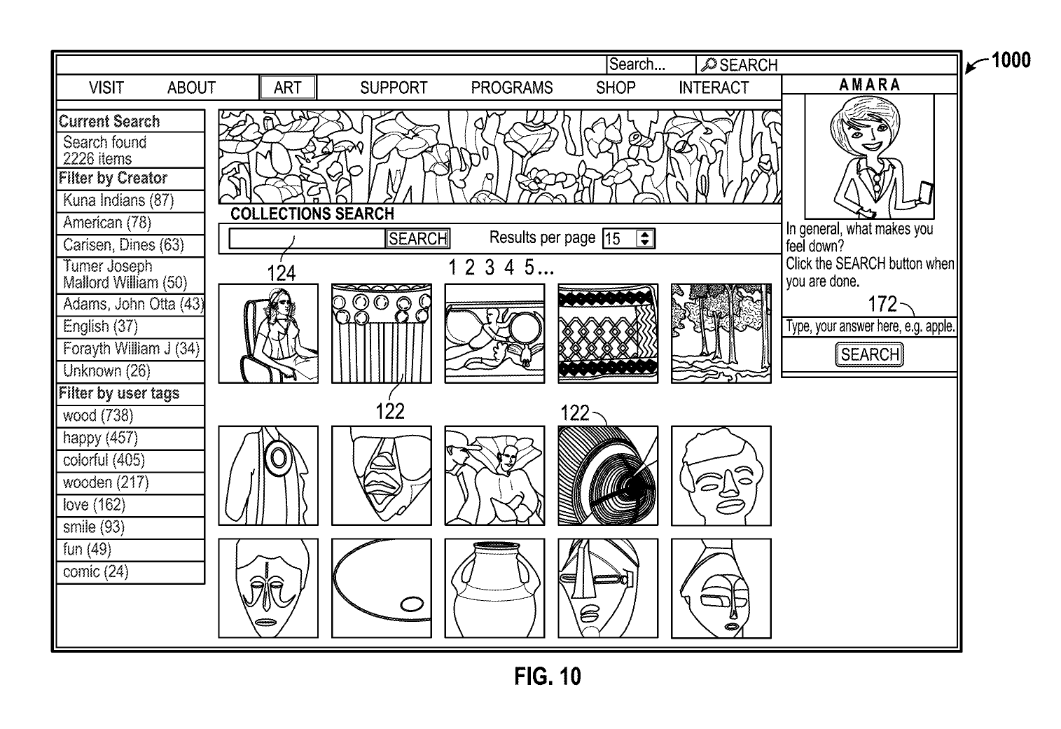

When the user clicks on one of the blocks 164, 166, 168, 170, system 100 moves to step 314 and further narrows down the results that were shown in GUI 900, which are shown in GUI 1000 in FIG. 10, with representations 122 being selected based on the representations 122 associated with those particular social tags.

In order to further narrow down the number of representations 122 that are displayed in GUI 1000, system 100 moves to step 314 and generates a new question, selected from TABLE IV below, in block 134. Note that, while GUI 900 (as well as GUI 600, 700, 800) generates multiple choice answers, GUI 1000 provides an open-ended question.

TABLE IV
Questions

What is your favorite color?
What color comes to mind when you think of your favorite food?
What animal do you want to see in paintings?
What is your favorite fruit?
What is your favorite season?
What accessory do you like to wear?
What kind of art genre do you like?
What is your ideal destination for a vacation?
What era of art do you like the most?
What is your favorite color when you select clothes?
What kind of weather do you prefer the most?
In general, what makes you feel down?
In general, what makes you feel happy?
What kind of object, artifact, people would you like to see in an artwork?
What country's artworks would you like to see?
Who is your favorite artist?
If you were an artist, what would you like to paint?
If you were a sculpture artist, what would you like to craft?
What animal do you think is the cutest?
Which fruit makes your mouth water?
What type of sparkling jewelry do you like the most?
What is your fantasy destination?
What do you find most beautiful about the human body?
What is your favorite scenery?
What makes you feel gloomy?
If you were an artist, what country would you want to be from?

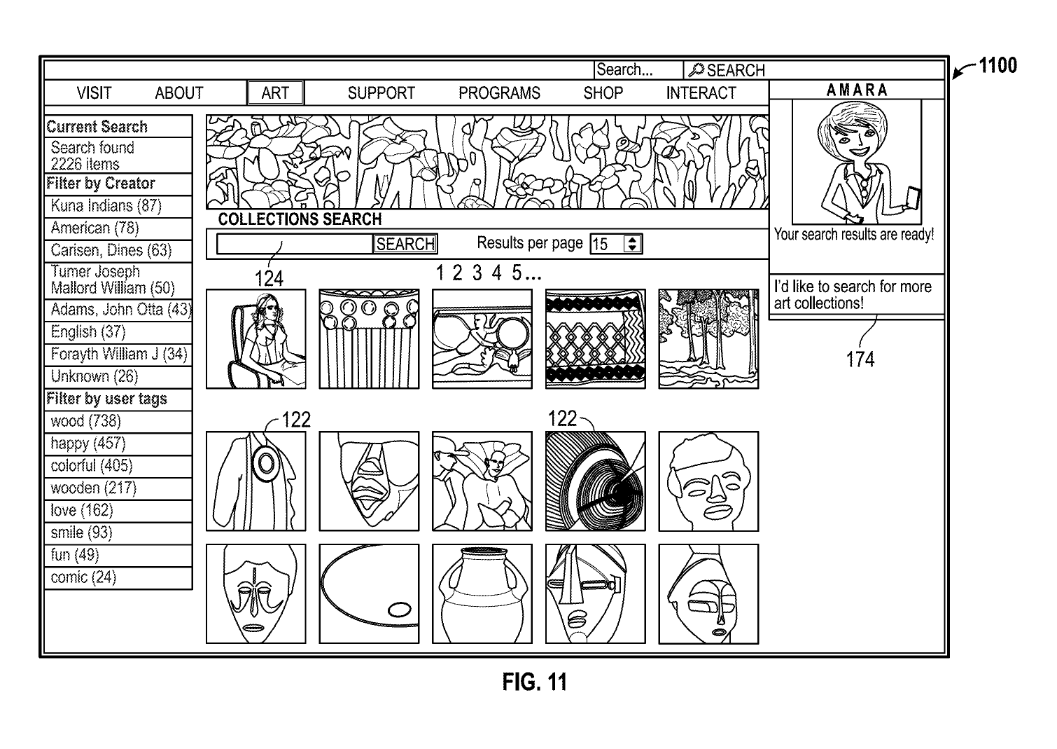

The user types an answer to the question in block 172 in GUI 1000. The answer is a social tag that is used to further narrow the number of representations 122 provided in GUI 1100, shown FIG. 11.

In step 316, system 100 provides the user the option to conduct a new search. If the user clicks on box 174, system 100 then returns to step 308 and repeats steps 308-316.

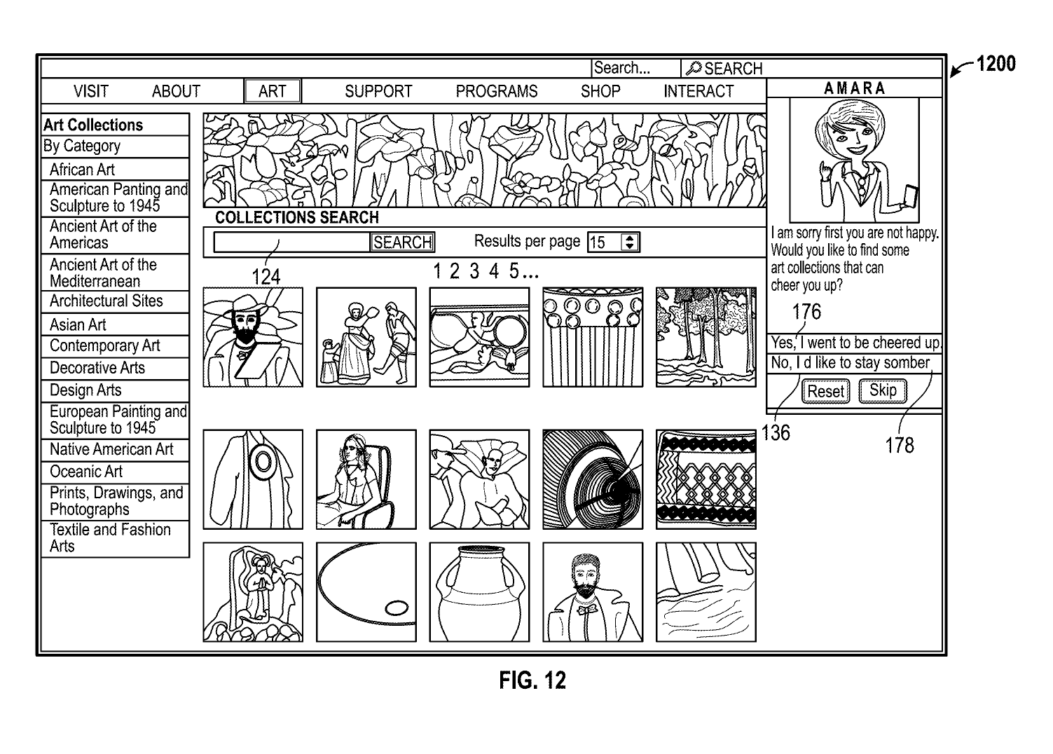

If, back in step 304 (GUI 500 and FIG. 5), the user clicks on box 148, system 100 moves to step 318 and generates GUI 1200, shown in FIG. 12. In step 318, system 100 asks the user if the user would like to be cheered up in box 176 or stay somber in box 178. Note that, in GUI 1200, the “Reset” button 140 is disabled. If the user would like to be cheered up, system 100 moves to step 308, shown in GUI 700 of FIG. 7 and system 100 proceeds as described above with respect to step 308. If, however, the user would like to stay somber, system 100 moves to step 320.

In step 320, a randomly generated positive question, selected from the first column of TABLE I above, is presented in box 134, shown in GUI 700 in FIG. 7. Potential answers to the question, selected from the second and third columns of TABLE I, are presented in boxes 154 and 156. After the user selects box 154 or box 156, system 100 moves to step 310 as described above.

If, at any time during steps 310-314 or 320, the user desires to restart the questioning process provided by system 100, the user can click on the “Reset” button 140, which will restart system 100 at step 302. Alternatively, if the user desires to skip the question, the user can click on the “Skip” button 142, which will then skip that particular step in the inventive process. For example, if the user is on step 310 and does not wish to answer the question generated at step 310, the user clicks on the “Skip” button 142, and system 100 jumps down to step 312.

While, in an exemplary embodiment, system 100 merely filters the artworks based on the user's answers to each individual question asked in steps 308-314, those skilled in the art will recognize that, as the user answers more questions, the results generated by system 100 may continuously narrow down. For example, if 200 pieces of artwork are located in the search based on the user's answer to the question in step 308, the artwork selected in the search based on the user's answer to the question in step 310 is drawn only from those previously selected 200 pieces of artwork. The process is repeated for the questions in steps 312 and 314. By the time that the user answers the question in step 314, the selected artworks may be narrowed down to as few as a dozen pieces of artwork, but these pieces may be extremely relevant to the user and his/her mood on that particular day.

Further, if the user's mobile device has a camera, the user can use a camera to take a picture of his/her facial expression. Using known facial recognition software, system 100 estimates the mood of the user and, instead of asking a question such as the question in any of steps 308-314, system 100 can ask a question about the user's mood and generate representations 122 based on the user's mood response.

Those skilled in the art will recognize that the questions and answers provided in TABLEs I, II, III, IV are exemplary in number and in nature and that a different number of questions and a different nature of the questions and answers as well as a different number and different types of social tags can be provided. After system 100 has generated a list of recommended artwork to view, system 100 may also generate a recommended electronically generated route on a user-operated mobile device for the user to follow to view the artwork provided through the question-and-answer process and provide directions throughout the museum for the user to follow. System 100 may also generate an approximate total length of time that it should take for the user to view the recommended artwork. The approximate length of time can be calculated by multiplying the number of pieces of recommended artwork by an average length of viewing time for each piece of artwork and adding an approximate length of walking time in between pieces. Additionally, resting time as well as lavatory time can also be included, depending on the total approximate time for the user to view the recommended artwork.

Optionally, in the event that the user knows that he/she does not have sufficient time to view all of the recommended artwork, the user can input an allotted time that the user has to view the artwork. In step 314, system 100 modifies the list of recommended artwork to view such that the user can view the most highly recommended artwork within the allotted time.

In an exemplary embodiment, the public access hours to the museum, particularly the closing time of the museum, can be provided within system 100. If the user is at the museum and is operating system 100 via a mobile device, system 100 calculates the remaining time available to tour the museum based on the present time and the museum's closing time and generates a list of recommended artwork from the representation selected after step 314 to view within the remaining time available to tour the museum that day. Alternatively, if the user has expressed an intention to visit the museum on a particular day and knows that approximate time when he/she expects to arrive at the museum or how much time he/she desires to spend at the museum, system 100 can calculate the time available to tour the museum based on the estimated arrival time and the closing time of the museum and generates a list of recommended artwork to view within that timeframe. Still alternatively, having calculated the total approximate time that would take the user to view all of the recommended artwork, system 100 can suggest a time by which the user should arrive at the museum in order to be able to view all of the recommended artwork before the museum closes.

In another exemplary embodiment, if the user is accessing system 100 via a mobile device, a global positioning system (GPS) tracker within the mobile device may determine the location of the user to within a predetermined radius of his/her actual location. For example, if the user is in the Louvre and the GPS system in the user's mobile device determines that the user standing close to the Mona Lisa, system 100 can query the user whether the user is actually viewing the Mona Lisa and, if so, system 100 displays information about the Mona Lisa to the user. Such information may be preprogrammed through system 100. Alternatively, system 100 may access an online system, such as Google or Wikipedia to provide updated information about the Mona Lisa.

Further, system 100 may interface with a local weather forecast and, the forecasted weather is inclement (i.e., rainy, snowy, cold, etc.), and if the user is intending to use system 100 to view outdoor cultural items such as, for example, historical monuments, system 100 can inform the user of the forecasted weather conditions and recommend alternative indoor locations to view.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of using social tagging to recommend cultural items, the method comprising:
a) providing an electronic database of cultural items, at least one of the cultural items having at least one descriptive keyword associated therewith;
b) providing to a first user a first query with a first plurality of predetermined answers;
c) associating each of the first plurality of predetermined answers with at least one of the descriptive keywords;
d) receiving a selection input of one of the first plurality of predetermined answers from the first user; and
e) displaying representations of the cultural items associated with at least one of the descriptive keywords associated with the one of the first plurality of predetermined answers to the first user.

2. The method according to claim 1, wherein the first query is randomly selected from a plurality of predetermined queries.

3. The method according to claim 1, further comprising, after step d), providing a second query with a second plurality of predetermined answers and associating each of the second plurality of predetermined answers with at least one of the descriptive keywords.

4. The method according to claim 3, wherein the second plurality of predetermined answers is a different value than the first of predetermined answers.

5. The method according claim 3, further comprising receiving a selection input of one of the second plurality of predetermined answers from the first user and displaying representations of the cultural items associated with at least one of the descriptive keyword associated with the one of the second plurality of predetermined answers to the first user.

6. The method according to claim 1, further comprising, in conjunction with step b), displaying a graphically embedded visual representation of the human.

7. The method according to claim 5, wherein the human comprises a female human.

8. The method according to claim 1, wherein the at least one descriptive keyword is provided by a second user.

9. The method according to claim 1, further comprising, after step d), allowing the first user to return directly to step b).

10. The method according claim 1, further comprising, after step d), the steps of:
f) providing a second query; and
g) providing a user interface allowing the first user to manually input a response to the second query.

11. The method according claim 10, further comprising, after step g), associating the response to the second query with at least one of the cultural items and displaying a representation of the at least one of the cultural items.

12. (canceled)

13. The method according to claim 1, wherein the cultural items comprise geographical locations.

14. (canceled)

15. The method according to claim 1, further comprising generating an electronically generated route for the first user to take in order to view the displayed cultural items.

16. The method according claim 1, further comprising generating an estimated time for the user to take in order to view the displayed cultural items.

17. The method according claim 1, further comprising receiving a timeframe from the first user and modifying the displayed list of representations of cultural items such that the first user has sufficient time within the timeframe to view the modified displayed list of cultural items.

18. The method according to claim 1, determining an accessible timeframe in which to view the cultural items and modifying the displayed list of representations of cultural items such that the first user has sufficient time within the accessible timeframe to view the modified displayed list of cultural items.

19. The method according to claim 1, further comprising, after step e), generating an approximate time for the first user to view the cultural items.

20. The method according to claim 1, further comprising providing access to a local weather forecast and modifying the displayed representations of the cultural items based on the weather forecast.

21. The method according claim 1, further comprising:
obtaining a graphical representation of the first user's face;
interpreting the first user's mood based on the graphical representation; and
generating a second query based on the interpretation.

22. The method according to claim 1, further comprising:
receiving a location of the first user relative to one of the cultural items;
querying the first user whether the first user is viewing the one of the cultural items; and
providing a graphical display of information related to the one of the cultural items to the first user.

23. (canceled)
